(19) United States
(12) Patent Application Publication
(10) Pub. No.: US 2026/0025207 A1
(43) Pub. Date: Jan. 22, 2026

(54) OPTICAL TRANSMISSION LINE MONITORING APPARATUS AND OPTICAL TRANSMISSION LINE MONITORING METHOD

(71) Applicant: Fujitsu Limited, Kawasaki-shi (JP)

(72) Inventors: Shoichiro ODA, Fuchu (JP); Kyosuke SONE, Kawasaki (JP); yoshitaka NOMURA, shinagawa (JP); KAZUYUKI TAJIMA, Yokosuka (JP)

(73) Assignee: Fujitsu Limited, Kawasaki-shi (JP)

(21) Appl. No.: 19/252,838

(22) Filed: Jun. 27, 2025

(30) Foreign Application Priority Data
Jul. 17, 2024 (JP) 2024-114033

(51) Int. Cl. H04B 10/293; H04B 10/2513

(52) U.S. Cl. CPC H04B 10/293; H04B 10/2513

(57) ABSTRACT

An optical transmission line monitoring apparatus includes a first compensator that compensates for a part of chromatic dispersion and a part of high-order chromatic dispersion of an optical transmission line with respect to an electric field signal, a nonlinear compensator that compensates for deterioration due to a nonlinear optical effect of the optical transmission line with respect to the electric field signal after compensation by the first compensator, a second compensator that compensates for the residual parts of the chromatic dispersion and the high-order chromatic dispersion with respect to the electric field signal after compensation by the nonlinear compensator, a generator that generates a reference signal based on the electric field signal, and an estimator that estimates a distribution of an optical power based on a correlation between the electric field signal after compensation by the second compensator and the reference signal.

### CROSS-REFERENCE TO RELATED APPLICATION

This application is based upon and claims the benefit of priority of Japanese Patent Application No. 2024-114033 filed on Jul. 17, 2024, the entire contents of which are incorporated herein by reference.

### FIELD

A certain aspect of the present embodiments relates to an optical transmission line monitoring apparatus and an optical transmission line monitoring method.

### BACKGROUND

There has been known an optical transmission system including a plurality of optical transmitters and a plurality of optical receivers. The plurality of optical transmitters and the plurality of optical receivers are communicably connected via an optical transmission line. The optical transmission line includes an optical fiber. The optical transmission system performs communication by a wavelength division multiplexing (WDM) system using the plurality of optical transmitters and the plurality of optical receivers (see, for example, International Publication Pamphlet No. WO 2023/037553).

For example, when the optical transmitter transmits an optical signal, the optical signal is transmitted through the optical transmission line. The optical receiver receives the optical signal transmitted through the optical transmission line (see, for example, Japanese Laid-Open Patent Publication No. 2023-177783). When an optical signal is WDM-transmitted, a distance over which the signal can be transmitted is limited by the chromatic dispersion of the optical fiber. Therefore, there has been proposed an optical receiver including a dispersion compensator for compensating for such chromatic dispersion (see, for example, Japanese Laid-Open Patent Publication No. 2006-262452). In addition, it is known that chromatic dispersion is reduced by using a dispersion compensation module (see, for example, U.S. Pat. No. 6,330,381).

### SUMMARY

According to an aspect of the present disclosure, there is provided an optical transmission line monitoring apparatus including: a first compensator that compensates for a part of chromatic dispersion and a part of high-order chromatic dispersion of an optical transmission line with respect to an electric field signal indicating an optical electric field component of an optical signal received by a digital coherent reception from the optical transmission line; a nonlinear compensator that compensates for deterioration due to a nonlinear optical effect of the optical transmission line with respect to the electric field signal after compensation by the first compensator; a second compensator that compensates for a residual part of the chromatic dispersion and a residual part of the high-order chromatic dispersion with respect to the electric field signal after compensation by the nonlinear compensator; a generator that generates a reference signal indicating the optical electric field component of the optical signal at a transmission end of the optical transmission line based on the electric field signal; and an estimator that estimates a distribution of an optical power based on a correlation between the electric field signal after compensation by the second compensator and the reference signal.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 illustrates an example of an optical transmission system.

FIG. 2 illustrates an example of the hardware configuration of an optical receiver and an optical transmission line monitoring apparatus.

FIG. 3 illustrates an example of the functional configuration of a DSP and an FPGA.

FIG. 4A illustrates an example of a power profile according to a comparative example.

FIG. 4B illustrates an example of a power profile according to an embodiment.

FIG. 5 illustrates an example of a power profile from a transmission end to a reception end and a partial enlarged view thereof.

FIG. 6A illustrates another example of the power profile according to the comparative example.

FIG. 6B illustrates an example of a moving average of the distribution of anomaly scores according to the comparative example.

FIG. 7A illustrates another example of the power profile according to the embodiment.

FIG. 7B illustrates an example of a moving average of the distribution of anomaly scores according to the embodiment.

FIG. 8 is a flowchart illustrating an example of the operation of the optical transmission line monitoring apparatus.

### DETAILED DESCRIPTION

In many cases, a dispersion compensation unit such as a dispersion compensator or a dispersion compensating module compensates for chromatic dispersion of the entire signal band of an optical signal at the center frequency of the optical signal. For this reason, a difference may occur between an amount of the chromatic dispersion to be compensated and an actual amount of the chromatic dispersion in both ends of the signal band.

In the case of realizing large capacity transmission in the optical transmission system, a symbol rate, which is the number of times of digital modulation per unit time, is increased, but this tends to increase the above-mentioned difference in the amount of the chromatic dispersion. When the difference in the amount of the chromatic dispersion increases, signal distortion after the chromatic dispersion is compensated increases, and the transmission performance of the optical transmission system deteriorates. Such a deterioration in transmission performance becomes more significant as the transmission distance of the optical signal increases.

Therefore, in the case of the dispersion compensation at a high symbol rate, the dispersion slope is compensated in addition to the compensation of the chromatic dispersion. The dispersion slope corresponds to a slope when the wavelength dependence of the chromatic dispersion is approximated by a linear function, that is, a value obtained by differentiating the chromatic dispersion once with respect to the wavelength. A value obtained by differentiating the chromatic dispersion more than once with respect to wavelength is called higher-order chromatic dispersion. By compensating both the chromatic dispersion and the dispersion slope, the deterioration in the transmission performance of the optical transmission system is suppressed even when the symbol rate is high.

Further, in addition to the dispersion compensation unit, some optical receivers may include an optical transmission line monitoring apparatus that monitors the optical transmission line and estimates the position of a loss occurring in the optical transmission line. The optical transmission line monitoring apparatus captures an electric field signal corresponding to an optical signal received by the optical receiver, and estimates the distribution of optical power in the optical transmission line based on the electric field signal. The optical transmission line monitoring apparatus can estimate the position of the loss occurring in the optical transmission line based on the distribution of the optical power.

However, the optical transmission line monitoring apparatus estimates the distribution of the optical power without considering the influence of the dispersion slope, although the influence of the chromatic dispersion is considered when estimating the distribution of the optical power. This causes a problem that the accuracy of the distribution of the optical power is low.

Accordingly, an object of one aspect of the present disclosure is to provide an optical transmission line monitoring apparatus and an optical transmission line monitoring method that estimate the distribution of an optical power with high accuracy.

Hereinafter, an embodiment of the present disclosure will be described with reference to the drawings.

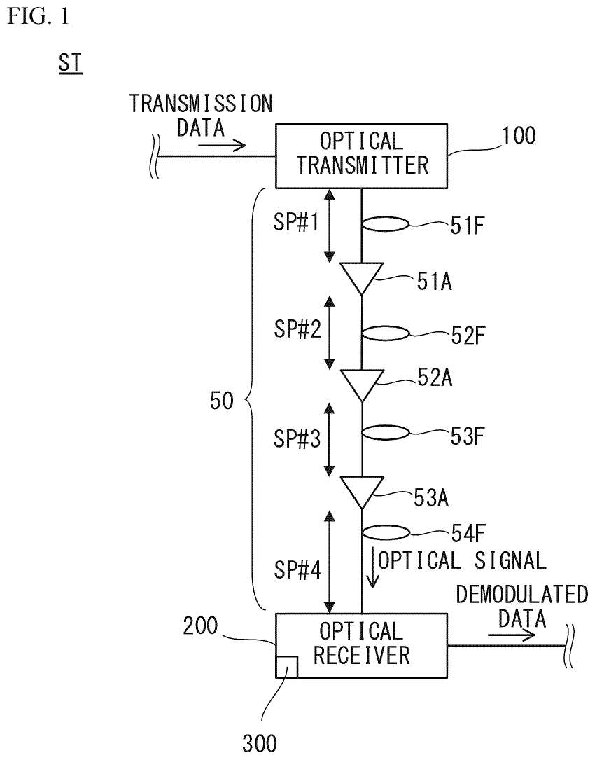

As illustrated in FIG. 1, an optical transmission system ST includes an optical transmitter 100 and an optical receiver 200. The optical transmitter 100 and the optical receiver 200 are connected by an optical transmission line 50. The optical transmitter 100 is provided at a transmission end of the optical transmission line 50, and the optical receiver 200 is provided at a reception end of the optical transmission line 50. When the transmission data is input, the optical transmitter 100 transmits an optical signal obtained by modulating the transmission data to the optical transmission line 50. The optical signal propagates through the optical transmission line 50. The optical receiver 200 receives the optical signal transmitted from the optical transmitter 100 from the optical transmission line 50, demodulates the optical signal, and outputs demodulated data.

A plurality of optical amplifiers 51A, 52A, and 53A are provided on the optical transmission line 50. Therefore, the optical transmission line 50 is divided into a plurality of transmission sections (hereinafter referred to as spans) SP #1, SP #2, SP #3, and SP #4 by the optical amplifiers 51A, 52A, and 53A. That is, the optical transmission line 50 is a multi-span optical transmission line including a plurality of spans SP #1, SP #2, SP #3, and SP #4 (hereinafter, referred to as SP #1, . . . , SP #4 as appropriate).

Optical fibers 51F, 52F, 53F, and 54F are laid in the plurality of spans SP #1, . . . , SP #4, respectively. For example, standard single mode fibers (SSMFs) are laid as optical fibers in spans SP #1, . . . , SP #4. A dispersion shifted fiber (DSF) may be laid as an optical fiber in part or in whole of the spans SP #1, . . . , SP #4.

The optical receiver 200 includes an optical transmission line monitoring apparatus 300. The optical transmission line monitoring apparatus 300 may be provided as a separate body from the optical receiver 200. In this case, the optical transmission line monitoring apparatus 300 may be included in an optical network controller that manages the optical transmission system ST. The optical transmission line monitoring apparatus 300 monitors the characteristics of the optical transmission line 50. The optical transmission line monitoring apparatus 300 acquires an electric field signal indicating an optical electric field component of an optical signal received by the optical receiver 200, which will be described in detail later.

The optical receiver 200 may be provided with an optical time domain reflectometer (OTDR). The OTDR can monitor the characteristics of the optical transmission line 50. However, when the OTDR is provided in the optical receiver 200, the manufacturing cost of the optical receiver 200 may increase, for example. In addition, the monitoring pulsed light used in the OTDR may exert a nonlinear influence on the optical signal. This makes it difficult to utilize OTDR during the operation of optical communication services. For this reason, in the present embodiment, the optical receiver 200 does not include the OTDR.

When the optical transmission line monitoring apparatus 300 acquires the electric field signal, the optical transmission line monitoring apparatus 300 calculates an estimated value of the optical power of the optical signal at a plurality of positions on the optical transmission line 50 based on the electric field signal, and estimates a power profile which is a distribution of the optical power. The power profile is, for example, a graph or distribution in which a horizontal axis represents a distance from the optical transmitter 100 and a vertical axis represents the estimated value of the optical power, which will be described in detail later. The characteristics of the optical transmission line 50 can be represented by the power profile.

Therefore, if the power profile can be accurately estimated, the optical transmission line monitoring apparatus 300 can accurately estimate the position of a loss occurring in the optical transmission line 50 based on the power profile. For example, the optical transmission line monitoring apparatus 300 can accurately estimate the position of an abnormal loss that affects transmission characteristics, such as vibration caused by construction or traffic, or aging degradation of the optical fiber. A surveillance monitor for displaying the power profile, the position of the loss, and the like may be connected to the optical transmission line monitoring apparatus 300. Thus, for example, an operator of the optical transmission system ST can confirm the power profile, the position of the abnormal loss, and the like.

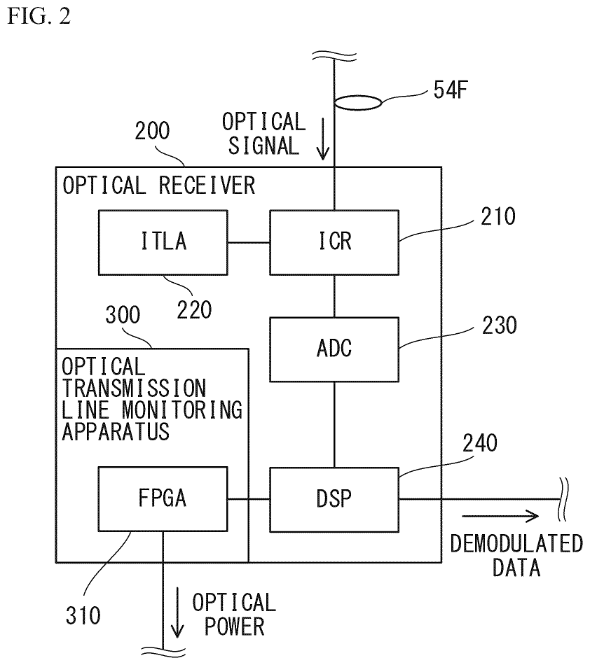

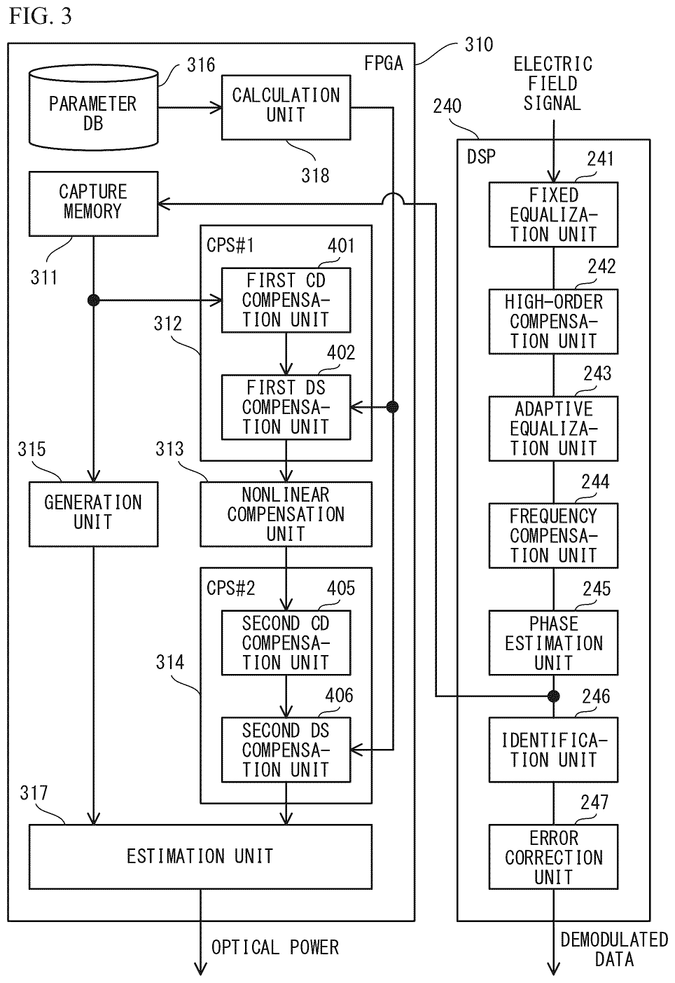

Next, the optical receiver 200 and the optical transmission line monitoring apparatus 300 will be described in detail with reference to FIGS. 2 and 3.

As illustrated in FIG. 2, the optical receiver 200 includes an integrated coherent receiver (ICR) 210 and an integrable tunable laser assembly (ITLA) 220. Although not illustrated, the ICR 210 includes a 90-degree optical hybrid circuit, a balanced photo diode (BPD), and a transimpedance amplifier (TIA). The ICR 210 is an integrated circuit that stores the 90-degree optical hybrid circuit, the BPD, and the TIA in one package. The optical receiver 200 includes an analogue digital converter (ADC) 230 and a digital signal processor (DSP) 240.

The ICR 210 receives an optical signal via the optical fiber 54F. The ITLA 220 includes a local oscillation light source that outputs local light (i.e., laser light). The ICR 210 digital-coherently receives the optical signal by using local oscillation light, converts the received optical signal into an electric field signal (specifically, an electric field information signal) corresponding to the optical signal, and outputs the electric field signal to the ADC 230. The ADC 230 converts the electric field signal from an analog form to a digital form and outputs the converted electric field signal to the DSP 240.

The DSP 240 receives the electric field signal output from the ADC 230 and performs various digital signal processes on the received electric field signal. As illustrated in FIG. 3, the DSP 240 includes a fixed equalization unit 241, a high-order compensation unit 242, an adaptive equalization unit 243, a frequency compensation unit 244, a phase estimation unit 245, an identification unit 246, and an error correction unit 247.

The fixed equalization unit 241 compensates for the chromatic dispersion suffered by the optical signal propagating through the optical transmission line 50 with respect to the electric field signal received by the DSP 240 on the whole. The fixed equalization unit 241 outputs the electric field signal after compensating for the chromatic dispersion to the high-order compensation unit 242.

The high-order compensation unit 242 compensates for the dispersion slope of the electric field signal output from the fixed equalization unit 241 on the whole. The dispersion slope is a value obtained by differentiating the chromatic dispersion once with respect to the wavelength, and is an example of the high-order chromatic dispersion. The high-order chromatic dispersion may include a value obtained by differentiating the chromatic dispersion twice or more with respect to the wavelength. For example, when the high-order compensation unit 242 considers the influence of only the dispersion slope, a transfer function H (ω, z) for calculating the compensation amount of the dispersion slope is expressed by the following equation (1). Note that β₃ is a third order dispersion coefficient (ps³/km). The symbol ω denotes an angular frequency.

$$H ( ω , z ) = exp ( - i \frac{{β}_{3}}{6} {ω}^{3} z ) \qquad ( 1 )$$

Accordingly, when the total length of the optical transmission line 50 is expressed by Zₜₒₜₐₗ (km), the transfer function H (ω, Zₜₒₜₐₗ) of the dispersion slope is expressed by the following equation (2). The transfer function H (ω, Zₜₒₜₐₗ) is previously included in the high-order compensation unit 242. The high-order compensation unit 242 compensates for the dispersion slope on the whole based on the transfer function H (ω, Zₜₒₜₐₗ).

$$H ( ω , {Z}_{total} ) = exp ( - i \frac{{β}_{3}}{6} {ω}^{3} {Z}_{total} ) \qquad ( 2 )$$

The adaptive equalization unit 243 adaptively compensates for residual dispersion in the electric field signal output from the high-order compensation unit 242. The residual dispersion is the chromatic dispersion that remains uncompensated by the fixed equalization unit 241 and the high-order compensation unit 242. The adaptive equalization unit 243 outputs the electric field signal after compensating for the residual dispersion to the frequency compensation unit 244.

The frequency compensation unit 244 compensates for a frequency offset with respect to the electric field signal output from the adaptive equalization unit 243. The frequency offset is a difference (or deviation) between an optical frequency of a transmission light source (not illustrated) provided in the optical transmitter 100 and an optical frequency of the ITLA 220. The frequency compensation unit 244 outputs the electric field signal after compensating for the frequency offset to the phase estimation unit 245. The phase estimation unit 245 compensates for the phase offset with respect to the electric field signal output from the frequency compensation unit 244, and estimates the phase of the optical signal. The phase offset is a difference (or deviation) between the phases of the transmission light source and the ITLA 220. The phase estimation unit 245 outputs the electric field signal after compensating for the phase offset to the identification unit 246.

The identification unit 246 demodulates the transmission data by identifying the value of each symbol based on the electric field signal output from the phase estimation unit 245, and outputs the demodulated transmission data to the error correction unit 247 as demodulated data. The error correction unit 247 corrects the bit error of the demodulated data and outputs the demodulated data after the error correction.

On the other hand, the optical transmission line monitoring apparatus 300 includes a field programmable gate array (FPGA) 310 as a hardware circuit, as illustrated in FIG. 2. The optical transmission line monitoring apparatus 300 may include an application specific integrated circuit (ASIC) as a hardware circuit instead of the FPGA 310. The optical transmission line monitoring apparatus 300 may include a processor including a central processing unit (CPU) and a memory instead of the FPGA 310.

The FPGA 310 receives the electric field signal output from the DSP 240 and performs various digital signal processes on the received electric field signal. As illustrated in FIG. 3, the FPGA 310 includes a capture memory 311 and a first compensation unit (denoted as CPS #1 in FIG. 3) 312. The FPGA 310 also includes a nonlinear compensation unit 313 and a second compensation unit (denoted as CPS #2 in FIG. 3) 314.

The first compensation unit 312 includes a first chromatic dispersion (CD) compensation unit 401 and a first dispersion slope (DS) compensation unit 402. The second compensation unit 314 includes a second CD compensation unit 405 and a second DS compensation unit 406.

The FPGA 310 further includes a generation unit 315, a parameter DB (DataBase) 316, an estimation unit 317, and a calculation unit 318. The first compensation unit 312, the nonlinear compensation unit 313, the second compensation unit 314, the generation unit 315, the estimation unit 317, the calculation unit 318, and the like are realized by the FPGA 310 executing a program according to a flowchart described later. The optical transmission line monitoring method of the present disclosure is realized by the FPGA 310 executing a program according to the flowchart described later.

The capture memory 311 stores the electric field signal output from the phase estimation unit 245 as a capture signal. The electric field signal output from the phase estimation unit 245 is a signal after the chromatic dispersion is compensated by the fixed equalization unit 241 and the dispersion slope is compensated by the high-order compensation unit 242. Therefore, the dispersion amount of the chromatic dispersion included in the capture signal is close to 0 (zero) ps/nm (picoseconds/nanometer). The dispersion slope amount of the dispersion slope included in the capture signal is also close to 0 (zero) ps/nm².

As illustrated in FIG. 3, the first CD compensation unit 401 acquires a capture signal from the capture memory 311. When the first CD compensation unit 401 acquires the capture signal, the first CD compensation unit 401 compensates for a part of the chromatic dispersion of the optical transmission line 50 with respect to the capture signal. More specifically, the first CD compensation unit 401 adds the chromatic dispersion of the entire optical transmission line 50, that is, the chromatic dispersion from the transmission end to the reception end, and compensates for the chromatic dispersion from the reception end to a monitor position. On the other hand, since the chromatic dispersion can be added, it may be rephrased that the first CD compensation unit 401 adds the chromatic dispersion from the transmission end to the monitor position. This is because that the difference between compensation and addition is only a difference in the sign of the amount of dispersion. The first CD compensation unit 401 outputs the capture signal after adding (or compensating for) a part of the chromatic dispersion of the optical transmission line 50, to the first DS compensation unit 402 as a monitor signal.

The first DS compensation unit 402 compensates for a part of the dispersion slope which is the high-order chromatic dispersion of the optical transmission line 50 with respect to the monitor signal after compensation by the first CD compensation unit 401, based on a first compensation amount described later. More specifically, the first DS compensation unit 402 adds the dispersion slope of the entire optical transmission line 50 and compensates for the dispersion slope from the reception end to the monitor position. On the other hand, since the dispersion slope can be added, it may be rephrased that the first DS compensation unit 402 adds the dispersion slope from the transmission end to the monitor position. The first DS compensation unit 402 outputs the monitor signal after adding (or compensating for) the dispersion slope of the optical transmission line 50 to the nonlinear compensation unit 313.

As illustrated in FIG. 3, the nonlinear compensation unit 313 compensates for the degradation of the optical transmission line 50 due to a nonlinear optical effect with respect to the monitor signal after compensation by the first DS compensation unit 402. As the nonlinear optical effect, for example, the Kerr effect can be cited. When the Kerr effect occurs, the refractive index of the optical fiber of the optical transmission line 50 changes in proportion to the square of the power of the optical signal. As a result, self-phase modulation occurs in the optical signal, and the pulse width becomes narrow due to the change in the phase velocity of the light, which causes a signal error. The nonlinear compensation unit 313 compensates for the deterioration of the optical transmission line 50 due to the nonlinear optical effect by performing phase rotation of an amount obtained by multiplying the square of the amplitude of the monitor signal by a predetermined value. The nonlinear compensation unit 313 outputs the monitor signal after compensation of the deterioration due to the nonlinear optical effect to the second CD compensation unit 405.

The second CD compensation unit 405 compensates for a residual part of the chromatic dispersion of the optical transmission line 50 with respect to the monitor signal after compensation by the nonlinear compensation unit 313. More specifically, the second CD compensation unit 405 compensates for the residual part of the chromatic dispersion from the monitor position to the transmission end. The second CD compensation unit 405 outputs the monitor signal after compensating for the residual part of the chromatic dispersion of the optical transmission line 50 to the second DS compensation unit 406.

The second DS compensation unit 406 compensates for the residual part of the dispersion slope which is the high-order chromatic dispersion of the optical transmission line 50, with respect to the monitor signal after compensation by the second CD compensation unit 405, based on a second compensation amount described later. More specifically, the second DS compensation unit 406 compensates for the residual part of the dispersion slope from the monitor position to the transmission end. The second DS compensation unit 406 outputs the monitor signal after compensating for the residual part of the dispersion slope of the optical transmission line 50 to the estimation unit 317.

When the Zₑₛₜᵢₘₐₜₑ is set in the calculation unit 318 as the distance for estimating the optical power, the calculation unit 318 acquires β₃ which is the third order dispersion coefficient stored in the parameter DB 316. Zₑₛₜᵢₘₐₜₑ corresponds to a distance from the transmission end to the monitor position. When the calculation unit 318 acquires β₃, the calculation unit 318 calculates the first compensation amount and the second compensation amount. When the calculation unit 318 calculates the first compensation amount and the second compensation amount, the calculation unit 318 sets the first compensation amount to the first DS compensation unit 402 and sets the second compensation amount to the second DS compensation unit 406.

The calculation unit 318 can calculate the first compensation amount by the following equation (3).

$$H ( ω , {Z}_{estimate} ) = exp ( - i \frac{{β}_{3}}{6} {ω}^{3} {Z}_{estimate} ) \qquad ( 3 )$$

The calculation unit 318 can calculate the second compensation amount by the following equation (4).

$$H ( ω , - {Z}_{estimate} ) = exp ( + i \frac{{β}_{3}}{6} {ω}^{3} {Z}_{estimate} ) \qquad ( 4 )$$

The generation unit 315 acquires the capture signal stored in the capture memory 311. Upon acquiring the capture signal, the generation unit 315 reproduces symbols from the capture signal, and demodulates the capture signal by identifying the value of each symbol to generate a reference signal that is a replica of the transmission data. The generation unit 315 may use transmission data prepared in advance as the reference signal without generating the reference signal. When the generation unit 315 generates the reference signal, the generation unit 103 outputs the reference signal to the estimation unit 317.

The estimation unit 317 calculates a correlation value of complex amplitudes of the monitor signal and the reference signal for each dispersion amount (specifically, a cumulative dispersion amount) based on the monitor signal output from the second DS compensation unit 406 and the reference signal output from the generation unit 315. When the correlation value is calculated, the estimation unit 317 outputs the calculated correlation value as an estimated value of the optical power for each dispersion amount. Since the magnitude of the self-phase modulation corresponds to the optical power at the monitor position, the estimation unit 317 can output the correlation value as the estimated value of the optical power. The estimation unit 317 can estimate the power profile based on the estimated value of the optical power. The estimation of the power profile can be performed with reference to, for example, Japanese Laid-Open Patent publication No. 2023-178193.

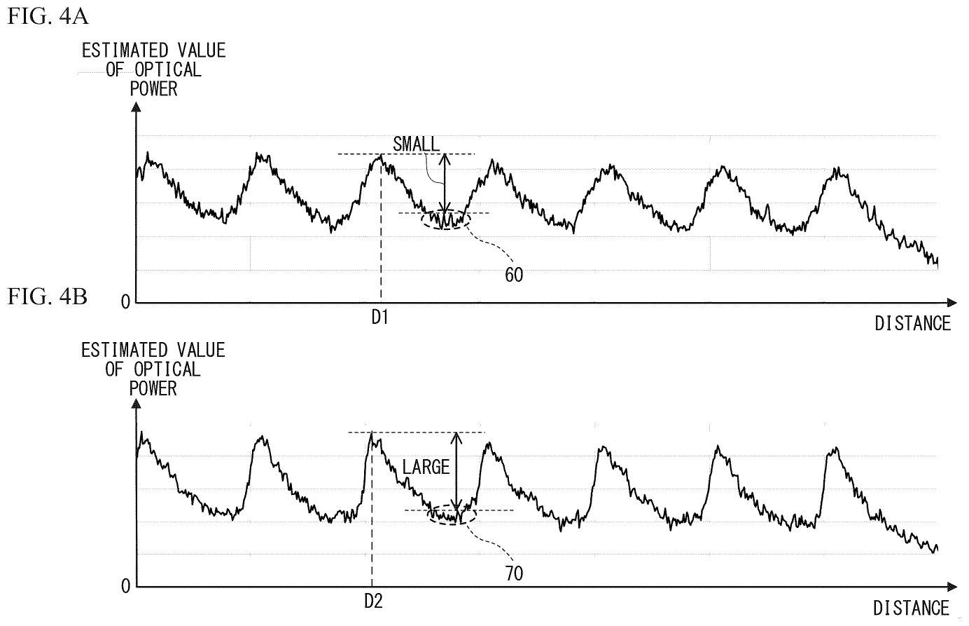

Next, an example of the effect of the present embodiment will be described in comparison with the comparative example with reference to FIGS. 4A and 4B. The horizontal axis of each of the power profiles illustrated in FIGS. 4A and 4B represents a distance from the transmission end, and the vertical axis of each of the power profiles represents an estimated value of the optical power. The horizontal axis of the power profile may be expressed by the cumulative dispersion amount from the transmission end. The comparative example illustrates a case where the first compensation unit 312 does not include the first DS compensation unit 402 and the second compensation unit 314 does not include the second DS compensation unit 406.

First, the peak value of the estimated value of the optical power can be specified relatively conspicuously even in the power profile according to the comparative example as illustrated in FIG. 4A or the power profile according to the embodiment as illustrated in FIG. 4B. For example, in the case of the distance D1 in the power profile according to the comparative example, the peak value of the estimated value of the optical power is uniquely specified. The peak value of the estimated value of the optical power is also uniquely specified at the distance D2 in the power profile according to the embodiment.

On the other hand, with respect to a bottom value of the estimated value of the optical power (specifically, the highest value appearing in the bottom portion of the estimated value of the optical power), the power profile according to the comparative example has a higher noise level 60 as illustrated in FIG. 4A. The reason why the noise level 60 is higher is that the influence of the nonlinearity is weakened. As a result, the estimated value of the optical power is buried in the noise level 60, and a noise ratio calculated based on the peak value and the bottom value tends to be small.

In the case of the comparative example in which the dispersion slope compensation is not performed in the optical transmission line monitoring apparatus 300, the accuracy of the power profile is lowered. That is, the power profile may deviate from an ideal power profile based on the design and specifications. Therefore, the optical transmission line monitoring apparatus 300 may not be able to detect the position of the loss occurring in the optical transmission line 50 with high accuracy in such a power profile.

However, in the power profile according to the embodiment, the influence of nonlinearity is not weakened, and a noise level 70 is lowered as illustrated in FIG. 4B. Therefore, the estimated value of the optical power is hardly buried in the noise level 70, and the noise ratio calculated based on the peak value and the bottom value tends to be large. That is, in the case of the embodiment in which the dispersion slope compensation is performed in the optical transmission line monitoring apparatus 300, the accuracy of the power profile is improved. Therefore, the optical transmission line monitoring apparatus 300 can detect the position of the loss occurring in the optical transmission line 50 with high accuracy based on such a highly accurate power profile.

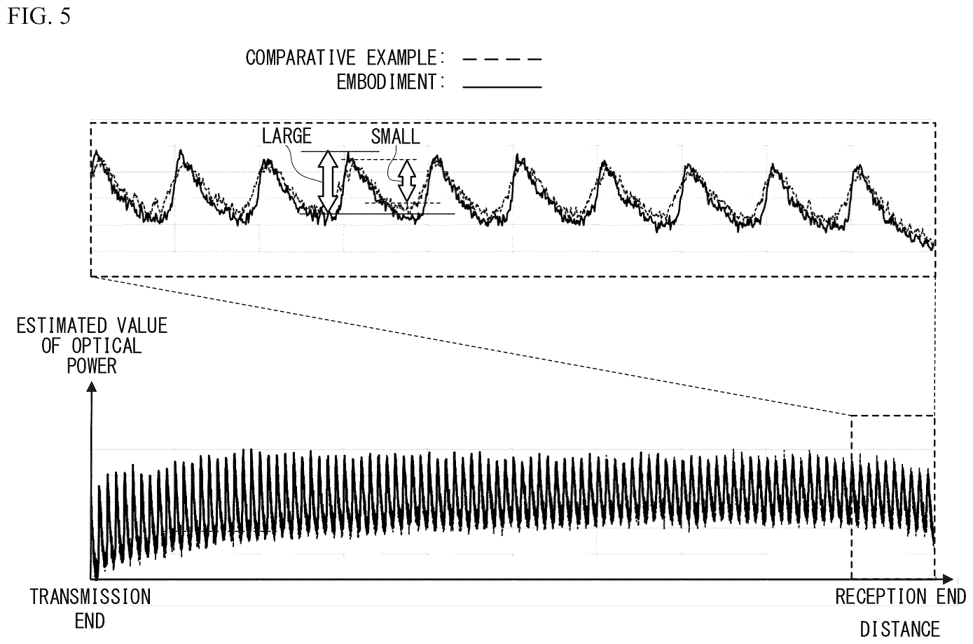

Referring to FIG. 5, another example of the effect of the present embodiment will be described in comparison with the comparative example. FIG. 5 illustrates a power profile in a submarine transmission system in which the influence of the dispersion slope is likely to occur. That is, the power profile is illustrated in the case where the optical transmission line 50 includes a large number of spans by providing a large number of optical amplifiers including a plurality of optical amplifiers 51A, 52A, and 53A in the optical transmission system ST. The power profile illustrated in the lower part of FIG. 5 represents an estimated value of the optical power from the transmission end to the reception end. The power profile illustrated in the upper part of FIG. 5 represents an estimated value of the optical power in the vicinity of the reception end.

As illustrated in the upper part of FIG. 5, in the comparative example, the noise ratio calculated based on the peak value and the bottom value tends to be small. That is, in the case of the comparative example in which the dispersion slope compensation is not performed in the optical transmission line monitoring apparatus 300, the accuracy of the power profile is lowered. On the other hand, in the embodiment, the noise ratio calculated based on the peak value and the bottom value tends to be large. That is, in the case of the embodiment in which the dispersion slope compensation is performed in the optical transmission line monitoring apparatus 300, the accuracy of the power profile is improved.

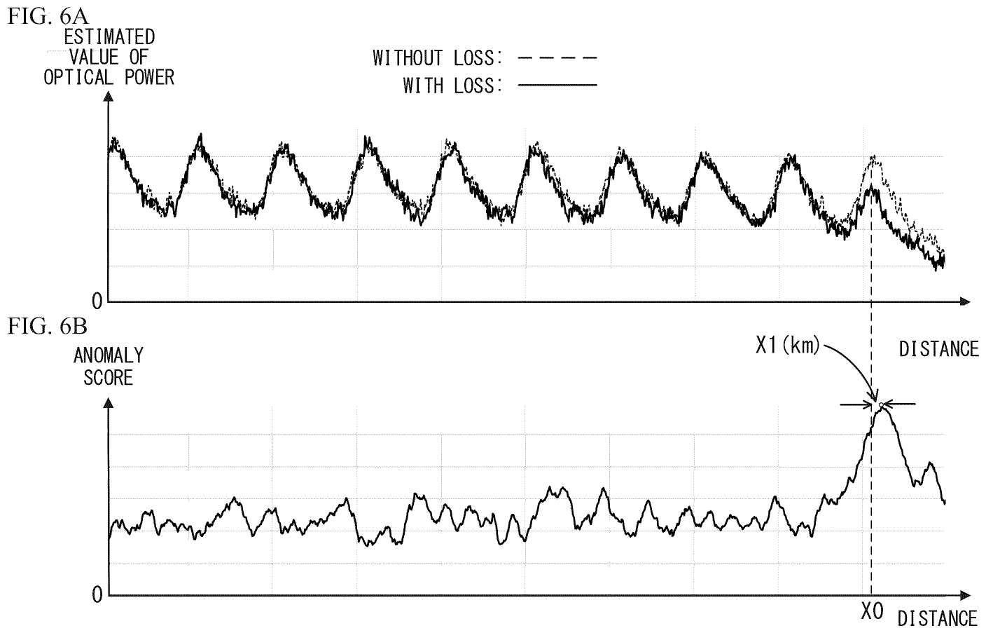

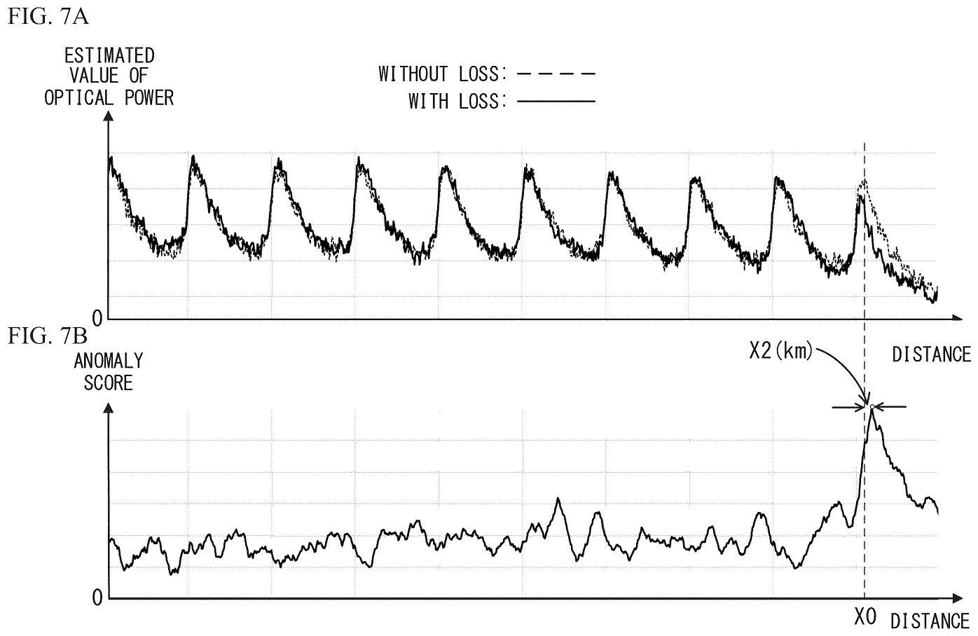

Referring to FIGS. 6A and 6B and FIGS. 7A and 7B, an example of the effect of the present embodiment according to the presence or absence of the loss will be described in comparison with the comparative example. Note that the loss is generated at a position away from the transmission end by X0 (km). The magnitude of the loss is about several decibels (dB).

First, as illustrated in FIG. 6A, in the case of the comparative example in which the dispersion slope is not compensated, the waveform of the power profile differs depending on the presence or absence of the loss. For example, in the vicinity of the position away from the transmission end by X0 (km), the peak value of the estimated value of the optical power with the loss is smaller than the peak value of the estimated value of the optical power without the loss. That is, the estimated value of the optical power decreases due to the occurrence of the loss in the vicinity of the position away from the transmission end by X0 (km).

Next, as illustrated in FIG. 6B, in the case of the comparative example in which the dispersion slope is not compensated, the peak value of the anomaly score corresponds to the peak value of the estimated value of the optical power. This is because the anomaly score is a difference between the estimated value of the optical power without the loss and the estimated value of the optical power with the loss. Here, a difference between the peak of the anomaly score and the position away from the transmission end by X0 (km) in the comparative example is X1 (km). That is, when the loss is caused at the position away from the transmission end by X0 (km), the position of occurrence of the loss that can be detected by the anomaly score is different from the actual position of occurrence of the loss. Specifically, in the case of the comparative example, an error of X1 (km) occurs as the position of occurrence of the loss.

On the other hand, as illustrated in FIG. 7A, also in the case of the embodiment in which the dispersion slope is compensated, the waveform of the power profile differs depending on the presence or absence of the loss. In the vicinity of the position away from the transmission end by X0 (km), the peak value of the estimated value of the optical power with the loss is smaller than the peak value of the estimated value of the optical power without the loss. That is, the estimated value of the optical power decreases due to the occurrence of the loss in the vicinity of the position away from the transmission end by X0 (km).

Next, as illustrated in FIG. 7B, also in the case of the embodiment in which the dispersion slope is compensated, the peak values of the anomaly score corresponds to the peak value of the estimated values of the optical power. Here, a difference between the peak of the anomaly score and the position away from the transmission end by X0 (km) in the embodiment is X2 (km). That is, when the loss is caused at the position away from the transmission end by X0 (km), the position of occurrence of the loss that can be detected by the anomaly score is different from the actual position of occurrence of the loss. Specifically, in the case of the comparative example, an error of X2 (km) occurs as the position of occurrence of the loss.

The error of X2 (km) in this embodiment is smaller than the error of X1 (km) in the comparative example. That is, since the error in the embodiment is smaller than that in the comparative example, the position of occurrence of the loss can be detected with high accuracy based on the anomaly score. In this way, when the power profile is generated, the position of occurrence of the loss is detected with high accuracy by taking the dispersion slope compensation into consideration.

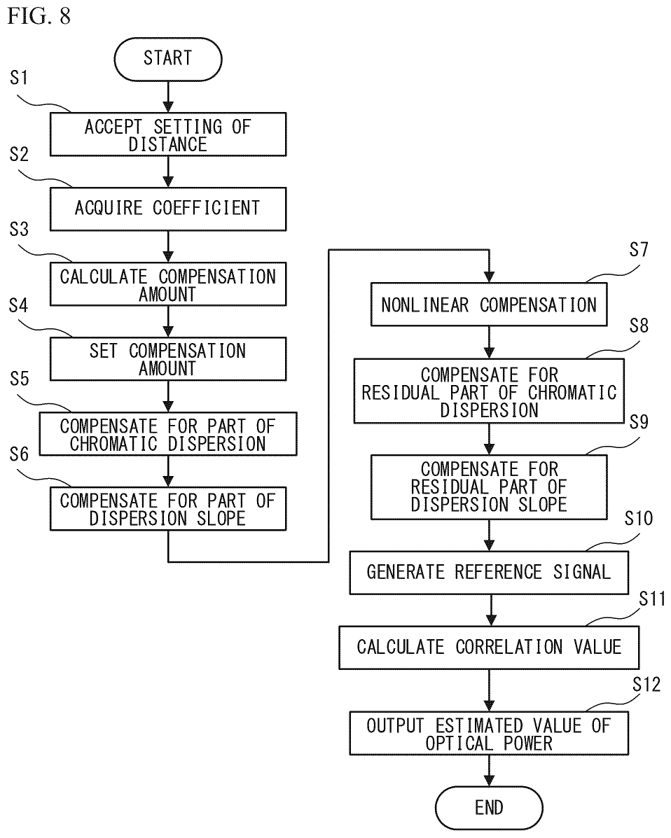

The operation of the optical transmission line monitoring apparatus 300 will be described with reference to FIG. 8.

First, the calculation unit 318 accepts the setting of the distance (step S1). More specifically, the calculation unit 318 accepts the setting of the above-described Zₑₛₜᵢₘₐₜₑ. As a result, the Zₑₛₜᵢₘₐₜₑ is set in the calculation unit 318. Upon receiving the setting of the distance, the calculation unit 318 acquires the coefficient (step S2). Specifically, when the Zₑₛₜᵢₘₐₜₑ is set, the calculation unit 318 acquires β₃ which is the third order dispersion coefficient stored in the parameter DB 316.

Upon acquiring the coefficient, the calculation unit 318 calculates the compensation amounts (step S3). More specifically, the calculation unit 318 calculates the first compensation amount based on the Zₑₛₜᵢₘₐₜₑ set in the calculation unit 318, the third order dispersion coefficient β₃, and the above-described equation (3). Moreover, the calculation unit 318 calculates the second compensation amount based on the Zₑₛₜᵢₘₐₜₑ set in the calculation unit 318, the third order dispersion coefficient β₃, and the above-described equation (4).

After calculating the compensation amount, the calculation unit 318 sets the compensation amounts (step S4). More specifically, the calculation unit 318 sets the first compensation amount in the first DS compensation unit 402. The calculation unit 318 sets the second compensation amount in the second DS compensation unit 406. When the calculation unit 318 sets the compensation amounts, the first CD compensation unit 401 compensates for a part of the chromatic dispersion (step S5). More specifically, the first CD compensation unit 401 acquires the capture signal from the capture memory 311 and compensates for the part of the chromatic dispersion of the optical transmission line 50 with respect to the capture signal.

After the first CD compensator 401 compensates for the part of the chromatic dispersion, the first DS compensator 402 compensates for a part of the dispersion slope (step S6). More specifically, the first DS compensation unit 402 compensates for the part of the dispersion slope of the optical transmission line 50 with respect to the monitor signal which is the capture signal after compensation by the first CD compensation unit 401, based on the first compensation amount.

When the first DS compensation unit 402 compensates for the part of the dispersion slope, the nonlinear compensation unit 313 executes nonlinear compensation (step S7). More specifically, the nonlinear compensation unit 313 compensates for the degradation of the optical transmission line 50 due to the nonlinear optical effect by performing phase rotation of an amount obtained by multiplying the square of the amplitude of the monitor signal by a predetermined value. When the nonlinear compensation unit 313 executes the nonlinear compensation, the second CD compensation unit 405 compensates for the residual part of the chromatic dispersion (step S8). More specifically, the second CD compensation unit 405 compensates for the residual part of the chromatic dispersion of the optical transmission line 50 with respect to the monitor signal after compensation by the nonlinear compensation unit 313.

After the second CD compensation unit 405 compensates for the residual part of the chromatic dispersion, the second DS compensation unit 406 compensates for the residual part of the dispersion slope (step S9). More specifically, the second DS compensation unit 406 compensates for the residual part of the dispersion slope of the optical transmission line 50 with respect to the monitor signal after compensation by the second CD compensation unit 405, based on the second compensation amount.

When the second DS compensation unit 406 compensates for the residual part of the dispersion slope, the generation unit 315 generates a reference signal (step S10). More specifically, the generation unit 315 acquires the capture signal stored in the capture memory 311, reproduces the symbols from the capture signal, and demodulates the capture signal by identifying the value of each symbol to generate the reference signal. The generation unit 315 outputs the reference signal when generating the reference signal.

When the generation unit 315 outputs the reference signal, the estimation unit 317 calculates a correlation value (step S11). More specifically, the estimation unit 317 calculates a correlation value of complex amplitudes of the monitor signal and the reference signal. When the correlation value is calculated, the estimation unit 317 outputs the calculated correlation value as the estimated value of the optical power (step S12), and the process is ended. The estimation unit 317 may estimate and output the power profile based on the estimated value of the optical power before the process is ended. The optical transmission line monitoring apparatus 300 may execute the process of steps S5 to S9 and the process of step S10 in parallel.

As described above, when estimating the power profile in consideration of the influence of nonlinearity, the optical transmission line monitoring apparatus 300 considers not only the influence of the chromatic dispersion but also the influence of the dispersion slope. This makes it possible to improve the accuracy of estimating the power profile of the optical transmission line monitoring apparatus 300.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention.

What is claimed is:

1. An optical transmission line monitoring apparatus comprising:
a first compensator that compensates for a part of chromatic dispersion and a part of high-order chromatic dispersion of an optical transmission line with respect to an electric field signal indicating an optical electric field component of an optical signal received by a digital coherent reception from the optical transmission line;
a nonlinear compensator that compensates for deterioration due to a nonlinear optical effect of the optical transmission line with respect to the electric field signal after compensation by the first compensator;
a second compensator that compensates for a residual part of the chromatic dispersion and a residual part of the high-order chromatic dispersion with respect to the electric field signal after compensation by the nonlinear compensator;
a generator that generates a reference signal indicating the optical electric field component of the optical signal at a transmission end of the optical transmission line based on the electric field signal; and
an estimator that estimates a distribution of an optical power based on a correlation between the electric field signal after compensation by the second compensator and the reference signal.

2. The optical transmission line monitoring apparatus according to claim 1, wherein
the high-order chromatic dispersion is a value obtained by differentiating the chromatic dispersion one or more times with respect to a wavelength.

3. The optical transmission line monitoring apparatus according to claim 1, wherein
the high-order chromatic dispersion is a dispersion slope.

4. The optical transmission line monitoring apparatus according to claim 1, further comprising
a calculator that calculates a first compensation amount to be set in the first compensator and a second compensation amount to be set in the second compensator based on a third order dispersion coefficient, a given transfer function determined in advance, and a distance from a position of the transmission end to a position where the optical power is estimated, when the high-order chromatic dispersion is a dispersion slope;
wherein the first compensator compensates for the part of the high-order chromatic dispersion based on the first compensation amount, and
the second compensator compensates for the residual part of the high-order chromatic dispersion based on the second compensation amount.

5. The optical transmission line monitoring apparatus according to claim 1, wherein
the first compensator compensates for the part of the high-order chromatic dispersion after compensating for the part of the chromatic dispersion, and
the second compensator compensates for the residual part of the high-order chromatic dispersion after compensating for the residual part of the chromatic dispersion.

6. An optical transmission line monitoring method comprising:
compensating for a part of chromatic dispersion and a part of high-order chromatic dispersion of an optical transmission line with respect to an electric field signal indicating an optical electric field component of an optical signal received by a digital coherent reception from the optical transmission line;
compensating for deterioration due to a nonlinear optical effect of the optical transmission line with respect to the electric field signal after compensating the part of chromatic dispersion and the part of high-order chromatic dispersion;
compensating for a residual part of the chromatic dispersion and a residual part of the high-order chromatic dispersion with respect to the electric field signal after compensating for the deterioration;
generating a reference signal indicating the optical electric field component of the optical signal at a transmission end of the optical transmission line based on the electric field signal; and
estimating a distribution of an optical power based on the reference signal and a correlation between the electric field signal after compensating the residual part of the chromatic dispersion and the residual part of the high-order chromatic dispersion.

7. The optical transmission line monitoring method according to claim 6, further comprising
calculating a first compensation amount for compensating for the part of the high-order chromatic dispersion and a second compensation amount for compensating for the residual part of the high-order chromatic dispersion based on a third order dispersion coefficient, a given transfer function determined in advance, and a distance from a position of the transmission end to a position where the optical power is estimated, when the high-order chromatic dispersion is a dispersion slope.
